(19) United States
(12) Patent Application Publication
(10) Pub. No.: US 2018/0112710 A1
(43) Pub. Date: Apr. 26, 2018

(54) Variable Stiffness Bushing For Shaft Support Assembly

(71) Applicant: GM GLOBAL TECHNOLOGY OPERATIONS LLC, Detroit, MI (US)

(72) Inventors: Robert J. Considine, Brighton, MI (US); Dennis M. Reich, Howell, MI (US)

(21) Appl. No.: 15/298,325

(22) Filed: Oct. 20, 2016

(51) Int. Cl. F16C 32/06; F16C 27/02; F16D 1/00; F16C 41/00; F16F 15/027; B60K 17/24

(52) U.S. Cl. CPC F16C 32/0629; F16C 27/02; F16D 1/00; F16C 41/00; F16F 15/0275; F16F 2228/066; F16C 2210/06; F16C 2326/06; F16D 2300/22; F16F 2222/06; F16F 2224/045; B60K 17/24

(57) ABSTRACT

A propeller shaft with a variable stiffness bushing is disclosed. The propeller shaft includes a first shaft and a second shaft, each of the first shaft and the second shaft having a first end and a second end, the second end of the first shaft coupled to the first end of the second shaft with a joint and a variable stiffness bushing assembly coupled to one of the first and the second shafts near the joint, the variable stiffness bushing assembly having a bearing, a bearing support encircling the bearing, a chamber formed in the bearing support, and at least one electric field generator, wherein the chamber contains a magnetorheological fluid.

### INTRODUCTION

The present invention relates generally to the field of vehicles and, more specifically, to a variable stiffness bushing for a shaft support assembly.

Propeller shafts which transmit power from an engine system to the wheel of an automotive vehicle are frequently constructed from one or more metal tubes connected with joints. The tubes forming the drive shaft often have relatively thin walls to minimize weight and rotating mass. The walls of the tubes can vibrate and generate noise due to excitation by vibration from other parts of the vehicle. Bushing assemblies for propeller shaft bearing assemblies tend to be made of rubber or other elastic material. However, there is a need for a more effective approach to reduce noise, vibration, and harshness effects caused by dynamic driveline events.

### SUMMARY

Embodiments according to the present disclosure provide a number of advantages. For example, embodiments according to the present disclosure reduce noise and vibration events caused by dynamic driveline events. Dynamic driveline events include, for example and without limitation, high torque, low speed vehicle operation as well as any mode of vehicle operation that may cause propshaft whirl. Propshaft whirl can occur at higher vehicle speeds due to 1^{st} order shaft imbalances. In some embodiments, 2^{nd} order vibrations due to a change of angles of the multiple shafts of the propshaft or driveshaft can be another cause of propshaft whirl.

In one aspect, an automotive vehicle is disclosed. The automotive vehicle includes a transmission; a differential; a propeller shaft connecting the transmission and the differential, the propeller shaft having a first shaft and a second shaft, each of the first shaft and the second shaft having a first end and a second end, the first end of the first shaft coupled to the transmission, the second end of the first shaft coupled to the first end of the second shaft, and the second end of the second shaft coupled to the differential; a bearing assembly configured to couple the second end of the first shaft to the first end of the second shaft, the bearing assembly comprising a bearing, a bearing support, a chamber formed within the bearing support, at least one electrical field generator embedded within the bearing support, the chamber filled with a magnetorheological fluid; wherein a stiffness of the bearing assembly is adjusted by varying an intensity of an electric field applied to the magnetorheological fluid.

In some aspects, the automotive vehicle further includes at least one sensor configured to detect a vehicle operation characteristic and a controller in electronic communication with the at least one electric field generator and the at least one sensor, the controller configured to receive sensor data from the at least one sensor and command an electric field intensity based on an operational mode of the vehicle. In some aspects, the operational mode of the vehicle is one of an active mode and a passive mode. In some aspects, the stiffness of the bearing assembly is higher when the vehicle is operating in the active mode than when the vehicle is operating in the passive mode.

In some aspects, the active mode includes a mode of operation of the vehicle in which the vehicle is towing a load. In some aspects, the active mode includes a mode of operation of the vehicle in which the bearing orbits in an elliptical direction along a longitudinal axis defined by the propeller shaft.

In another aspect, a propeller shaft includes a first shaft and a second shaft, each of the first shaft and the second shaft having a first end and a second end, the second end of the first shaft coupled to the first end of the second shaft with a joint; and a variable stiffness bushing assembly coupled to one of the first and the second shafts near the joint, the variable stiffness bushing assembly having a bearing, a bearing support encircling the bearing, a chamber formed in the bearing support, and at least one electric field generator, wherein the chamber contains a magnetorheological fluid.

In some aspects, the at least one electric field generator is embedded in a wall of the chamber. In some aspects, the propeller shaft transmits power from a vehicle transmission to at least one vehicle wheel. In some aspects, the at least one electric field generator is configured to generate a desired electric field intensity based on an operational mode of the vehicle. In some aspects, the operational mode of the vehicle is one of an active mode and a passive mode. In some aspects, a stiffness of the bushing assembly is higher when the vehicle is operating in the active mode than when the vehicle is operating in the passive mode. In some aspects, the active mode includes a mode of operation of the vehicle in which the bearing orbits in an elliptical direction along a longitudinal axis defined by the propeller shaft.

In yet another aspect, a method for controlling a variable stiffness bushing assembly of a vehicle is disclosed. The method includes the steps of providing the vehicle with at least one sensor configured to measure at least one vehicle characteristic; providing the vehicle with the variable stiffness bushing assembly, the bushing assembly comprising a bearing and a bearing support encircling the bearing, a chamber formed in the bearing support, the chamber containing a magnetorheological fluid, and at least one electric field generator embedded in a wall of the chamber; providing the vehicle with a controller in electronic communication with the at least one sensor and the at least one electric field generator; receiving, by the controller, vehicle data corresponding to the at least one vehicle characteristic from the at least one sensor; determining, by the controller, a desired damping level based on the vehicle data; and controlling, by the controller, the at least one electric field generator to generate a desired electric field intensity.

In some aspects, the method further includes the steps of determining, by the controller, an operational mode of the vehicle and commanding, by the controller, the desired electric field intensity based on the operational mode of the vehicle. In some aspects, the operational mode of the vehicle is one of an active mode and a passive mode. In some aspects, the stiffness of the bushing assembly is higher when the vehicle is operating in the active mode than when the vehicle is operating in the passive mode.

In some aspects, the method further includes the step of accessing, by the controller, information stored on a non-transient storage medium regarding a magnetorheological fluid viscosity for the desired electric field intensity. In some aspects, the method further includes the step of determining, by the controller, the desired field intensity based on the desired damping level. In some aspects, the at least one vehicle characteristic includes one or more of a vehicle speed, a vehicle acceleration, and a vehicle deceleration.

### BRIEF DESCRIPTION OF THE DRAWINGS

The present disclosure will be described in conjunction with the following figures, wherein like numerals denote like elements.

FIG. 1 is a schematic diagram of a vehicle having a variable stiffness bushing assembly for a propeller shaft support assembly, according to an embodiment.

FIG. 2 is a top view of a drivetrain for a vehicle, such as the vehicle of FIG. 1, according to an embodiment.

FIG. 3 is a front perspective view of a carrier bearing assembly for a vehicle drivetrain according to the prior art.

FIG. 4 is a cross-sectional view of a variable stiffness bushing assembly for a vehicle drivetrain, according to an embodiment.

FIG. 5 is another cross-sectional view of the variable stiffness bushing assembly of FIG. 4.

FIG. 6 is a schematic block diagram of a controller for a vehicle having a variable stiffness bushing assembly, according to an embodiment.

FIG. 7 is a flow chart of a process to tune the damping effect of the variable stiffness bushing assembly of FIG. 4, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

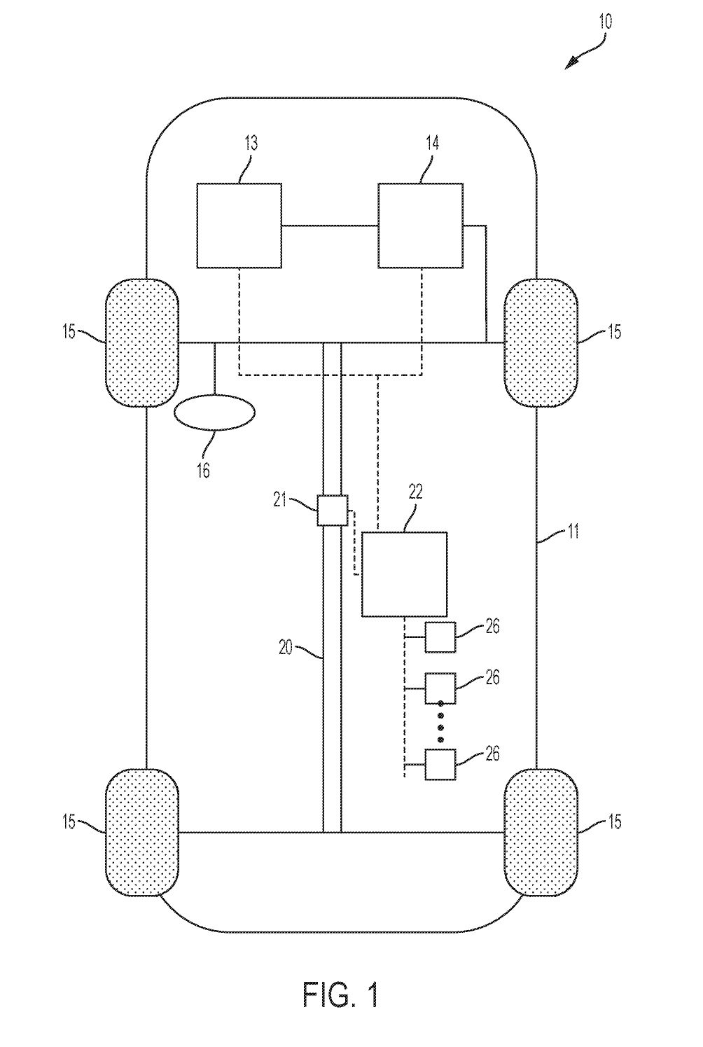

FIG. 1 schematically illustrates an automotive vehicle 10 according to the present disclosure. The vehicle 10 generally includes a body 11 and wheels 15. The body 11 encloses the other components of the vehicle 10. The wheels 15 are each rotationally coupled to the body 11 near a respective corner of the body 11. The vehicle 10 is depicted in the illustrated embodiment as a passenger car, but it should be appreciated that any other vehicle, including motorcycles, trucks, sport utility vehicles (SUVs), or recreational vehicles (RVs), etc., can also be used.

The vehicle 10 includes a propulsion system 13, which may in various embodiments include an internal combustion engine, an electric machine such as a traction motor, and/or a fuel cell propulsion system. The vehicle 10 also includes a transmission 14 configured to transmit power from the propulsion system 13 to the plurality of vehicle wheels 15 according to selectable speed ratios. According to various embodiments, the transmission 14 may include a step-ratio automatic transmission, a continuously-variable transmission, or other appropriate transmission. A drivetrain 20 transfers power from the transmission 14 to the wheels 15. The drivetrain 20 includes a propeller shaft bearing support assembly 21 that includes a variable stiffness bushing assembly, discussed in further detail below. The vehicle 10 additionally includes wheel brakes (not shown) configured to provide braking torque to the vehicle wheels 15. The wheel brakes may, in various embodiments, include friction brakes, a regenerative braking system such as an electric machine, and/or other appropriate braking systems.

The vehicle 10 additionally includes a steering system 16. While depicted as including a steering wheel and steering column for illustrative purposes, in some embodiments, the steering system 16 may not include a steering wheel. The vehicle 10 also includes a plurality of sensors 26 configured to measure and capture data on one or more vehicle characteristics, including but not limited to vehicle speed, vehicle acceleration, vehicle deceleration, steering angle, and vehicle heading. In the illustrated embodiment, the sensors 26 include, but are not limited to, an accelerometer, a speed sensor, a heading sensor, gyroscope, steering angle sensor, or other sensors that sense observable conditions of the vehicle or the environment surrounding the vehicle and may include additional sensors as appropriate.

The vehicle 10 includes at least one controller 22. While depicted as a single unit for illustrative purposes, the controller 22 may additionally include one or more other controllers, collectively referred to as a “controller.” The controller 22 may include a microprocessor or central processing unit (CPU) or graphical processing unit (GPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

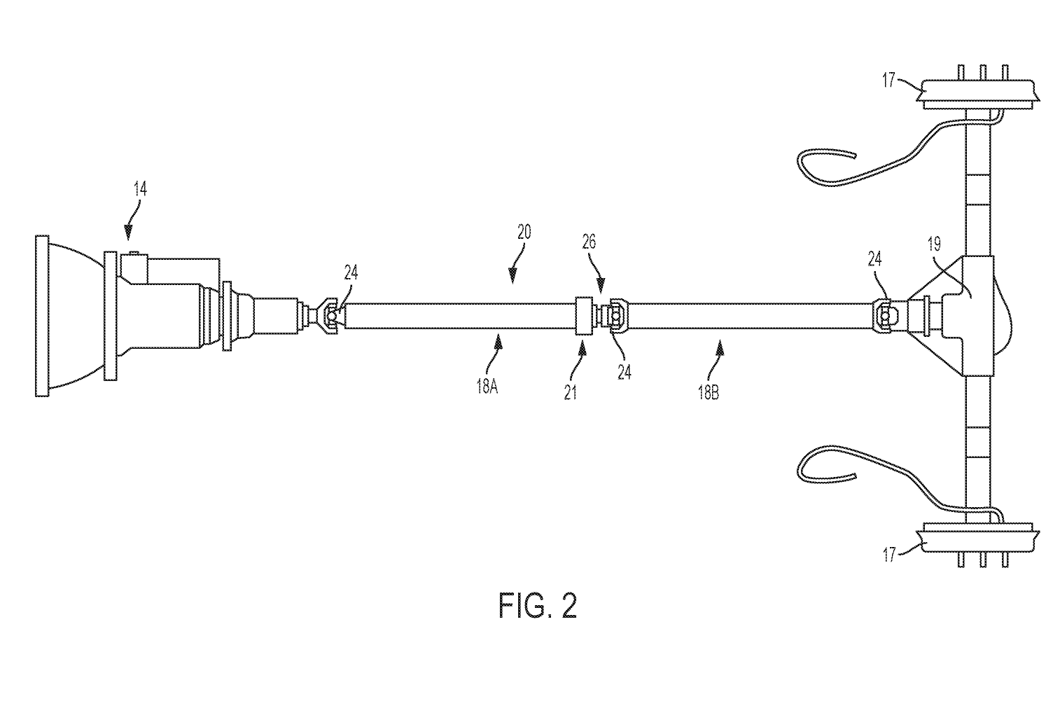

The drivetrain 20 transfers power from the transmission 14 to the wheel hubs 17 (shown in FIG. 2). The drivetrain 20 includes one or more tubes or shafts 18A, 18B coupled together by joints 24. With continued reference to FIG. 2, the transmission 14 is connected to a differential 19 by the pair of tubes 18A, 18B that are coupled by cardan, constant velocity, or other style joints 24 to one another and to the transmission 14 and the differential 19. The tubes 18A, 18B together form a propeller or drive shaft assembly 26 for transmitting torque from the transmission 14 to the differential 19. While a pair of tubes 18A, 18B are shown in FIG. 2, the propeller shaft assembly 26 may include 3, 4, or more tubes. A propeller shaft or carrier bearing support assembly 21 helps to support the drive shaft and reduce noise, vibration, and harshness effects transmitted to the passengers of the vehicle 10.

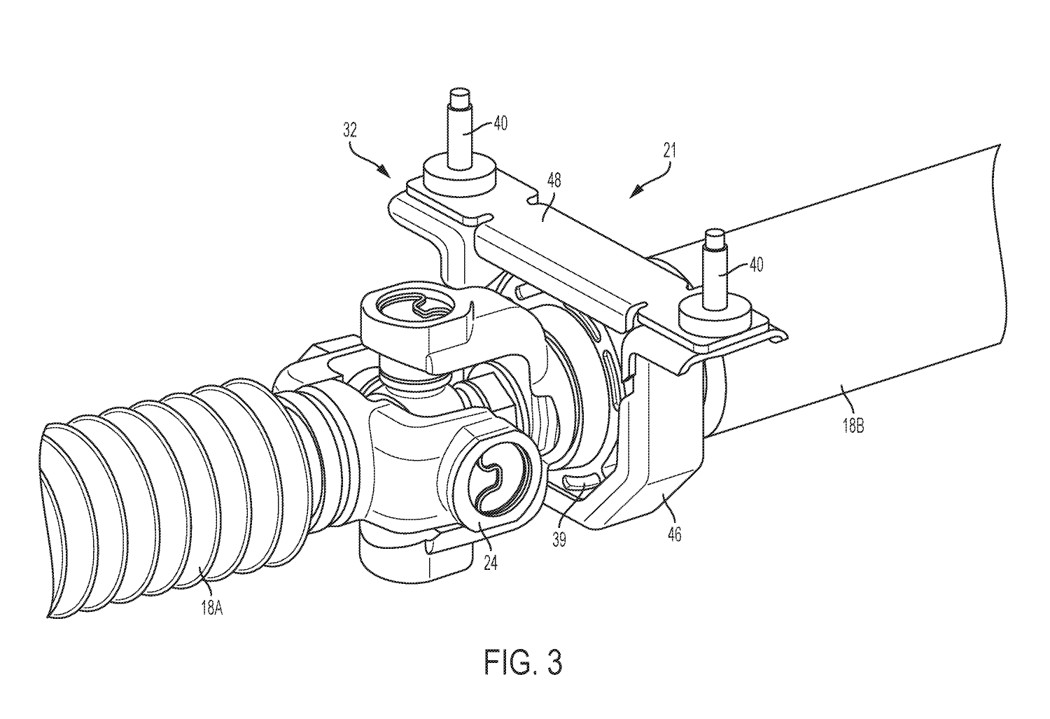

FIG. 3 illustrates a carrier bearing support assembly 21 according to a previously known embodiment. A carrier bearing assembly is an intermediate bearing assembly that connects the drive shafts of the vehicle 10. As shown in FIG. 3, the carrier bearing assembly 21 connects the tubes 18A, 18B of the propeller shaft assembly 26. The carrier bearing support assembly 21 is connected with the joint 24, which may be any type of joint, such as a Cardan joint, Constant Velocity, or other style of joint used for rear wheel, all wheel, and four wheel drive vehicles. In some embodiments, the carrier bearing support assembly 21 includes a bracket assembly 32. The bracket assembly 32 includes a U-shaped support bracket 46 and a top plate 48. The support bracket 46 and the top plate 48 are secured together by any type of mechanical fastener, such as fasteners 40. The bracket assembly 32 supports a bearing and a bearing support material 39. In this previously known embodiment, the support material 39 is made of rubber or a similar elastic material that surrounds the bearing to help control and minimize driveline dynamic events. However, when the vehicle is operating in an active mode, such as under heavy loading and towing events which cause high driveline angles and high torque, the bearing can orbit or whirl in an elliptical direction along a longitudinal axis defined by the propeller shaft/bearing center line. In some embodiments, propshaft whirl can happen at higher speeds due to 1^{st} order shaft imbalances. In some embodiments, 2^{nd} order vibrations due to change of angles can be another cause of propshaft whirl.

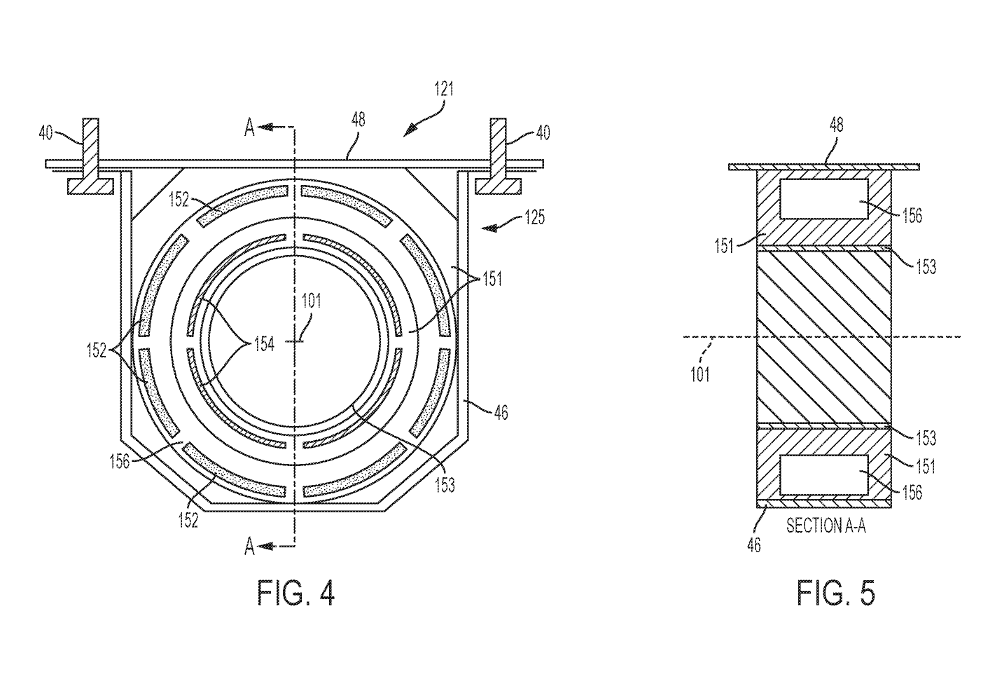

FIGS. 4 and 5 illustrate an improved carrier bearing support assembly 121 that includes a variable stiffness bushing assembly 125. The variable stiffness bushing assembly 125 includes a magnetorheological fluid (MR fluid) chamber formed in an elastic center bearing support. An MR fluid is a type of fluid having magnetic particles suspended within a carrier fluid, such as an oil. In the absence of an applied magnetic field, the fluid has a low viscosity but becomes quasi-solid with the application of a magnetic field. When subjected to a magnetic field, the particles align themselves generally along lines of magnetic flux and the MR fluid greatly increases its apparent viscosity to the point of becoming a viscoelastic solid. When the fluid is in its active or “on” state, the yield stress of the fluid can be accurately controlled by varying the magnetic field intensity.

With reference to FIGS. 4 and 5, the carrier bearing support assembly 121 includes a bracket assembly including a U-shaped support bracket 46 and a top plate 48. The support bracket 46 and the top plate 48 are secured by any type of mechanical fastener, such as fasteners 40. The bracket assembly supports the variable stiffness bushing assembly 125 that includes a bearing/bushing outer shell 153 and a bearing support 151. In some embodiments, the bearing support 151 and the bushing outer shell 153 are formed from rubber or a similar elastic material. Embedded within the bearing support 151 are a plurality of electric field generators 152, 154. As shown in FIG. 4, an array of electric field generators 152 are placed at a specified radial distance from a longitudinal axis 101 defined by the propeller shaft/bearing center line. The placement of the electric field generators 152 is dependent on the geometry of the propeller shaft/bearing center line. In some embodiments, the electric field generators 152 are placed in a range of radial distance of approximately 2 cm to approximately 8 cm from the longitudinal axis 101 depending on the size of the propeller shaft. The electric field generators 152 are composed of conductive materials of varying thickness such as aluminum and/or copper alloys. In some embodiments, including the embodiment shown in FIG. 4, eight (8) equally spaced electric field generators 152 are placed at a distance of approximately 4 cm from the longitudinal axis 101.

Additionally, a scaled array of similar electric field generators 154 are symmetrically placed surrounding the longitudinal axis 101 defined by the propeller shaft/bearing center line. Similar to the electric field generators 152, the placement of the electric field generators 154 depends on the geometry of the propeller shaft. In some embodiments, the electric field generators 154 are placed at a range of radial distance between approximately 1 cm and approximately 7 cm from the longitudinal axis 101 depending on the size of the propeller shaft as well as the radius of placement of the electric field generators 152. The electric field generators 154 are composed of conductive materials such as aluminum and or copper alloys having varying thickness. In some embodiments, including the embodiment shown in FIG. 4, four (4) equally spaced electric field generators 154 are placed at a distance of approximately 2 cm form the longitudinal axis 101.

An MR chamber 156 is formed within the bearing support 151. In some embodiments, the MR chamber 156 is a continuous open void or chamber having a centerline at a radial distance from the centerline of the propeller shaft. The MR chamber 156 is filled with an MR fluid. The MR fluid includes magnetic particles suspended in a carrier fluid, such as an oil. The MR chamber 156 is sized according to the geometry of the propeller shaft and will vary depending on the volume of fluid needed to influence the dynamic response of the propeller shaft. In some embodiments, two or more MR chambers 156 may be formed radially within the bearing support 151. The additional chambers allow for additional tuning of the damper created by the interaction of an electric field with the magnetic particles of the MR fluid.

The electric field generators 152 are embedded along the outer perimeter of the MR chamber 156. The electric field generators 154 are also embedded in the bearing support 151 closer to the centerline of the propeller shaft than the electric field generators 152. The electric field generators 152, 154 may be embedded within the bearing support 151 during molding and fabrication of the bearing support 151 or may be embedded after formation of the bearing support 151. Placement of the electric field generators 152, 154 within the walls of the MR chamber 156 depends on the cost and complexity of manufacture of the variable stiffness bushing assembly 125. In some embodiments, the electric field generators 152, 154 are contained and protected within the walls of the MR chamber 156 such that the electric field generators 152, 154 are not exposed to the outside environment or contaminated by the MR fluid located in the MR chamber 156. In some embodiments, both rings of electric field generators 152, 154 are located within the walls of the MR chamber 156. In some embodiments, the electric field generators 152 are located within the walls of the MR chamber 156 and the electric field generators 154 are located outside of the MR chamber 156.

In some embodiments, the electric field generators 152, 154 receive power via an electrical connection with the controller 22. Additionally, the controller 22 is configured to control the electric field generators 152, 514 to turn the electric field on and off, and vary the intensity of the electric field based on vehicle and driving conditions, such as high torque, low speed operation, vehicle towing operation, or normal driving operation, as discussed in greater detail below.

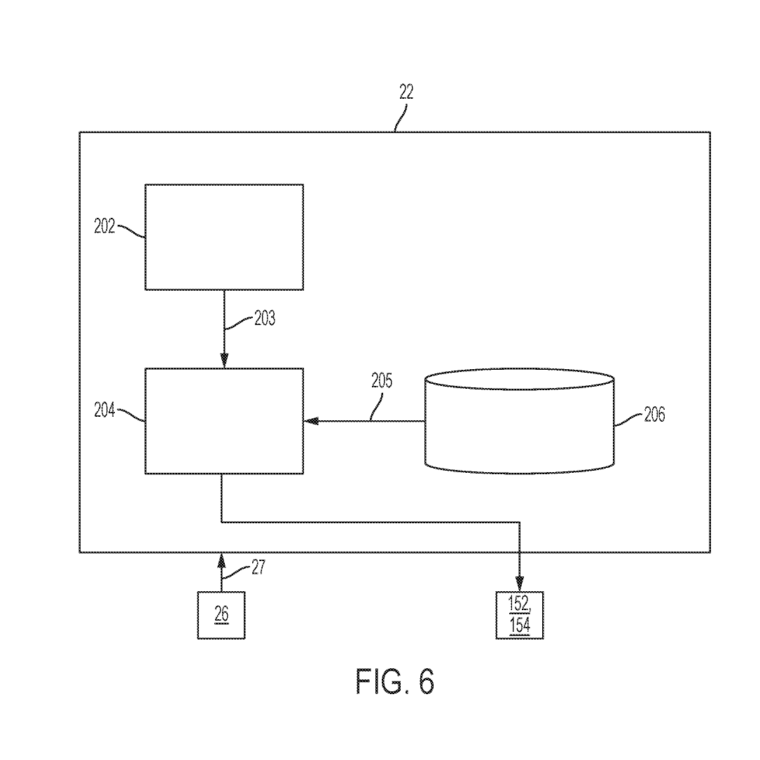

FIG. 6 is a block diagram of the controller 22. The controller 22 includes modules configured to monitor vehicle operating conditions and modulate the electromagnetic field used to control the viscosity of the MR fluid contained in the MR chamber 156 of the variable stiffness bushing assembly based on the detected operating conditions. In an exemplary embodiment, the controller 22 includes a MR fluid system monitoring module 202, a MR fluid system control module 204, and a storage medium 206 for storing a look up table listing electric field intensity settings for the electric field generators 152, 154 to generate the desired MR fluid response for a given operating condition.

The MR fluid system monitoring module 202 receives input on vehicle characteristics, such as vehicle speed, vehicle acceleration, vehicle deceleration, or other vehicle characteristics. The MR fluid system monitoring module 202 is configured to receive sensor data 27 from the plurality of sensors, such as the sensors 26 illustrated in FIG. 1. The senor data 27 received from sensors 26 includes, for example and without limitation, information on vehicle operation and driving conditions, such as acceleration and deceleration events, whether the vehicle is towing a trailer (as detected, in some embodiments, via a trailer wiring connection from the trailer to the vehicle 10), and user input via a user input device, such as a tow haul push button.

The MR fluid monitoring module 202 processes and synthesizes the inputs from the variety of sensors 26, including any user input, and generates a monitoring output 203. The monitoring output 203 includes various calculated parameters including, but not limited to, a determination as to whether the vehicle is operating under normal driving conditions (such as a passive mode) or is operating in a mode in which increased bearing stiffness is desired to reduce or prevent the shaft from whirling (such as an active mode). In some embodiments, the stiffness of the bushing assembly 125 is higher when the vehicle is operating in the active mode than when the vehicle is operating in the passive mode.

With continued reference to FIG. 6, the controller 22 includes the MR fluid system control module 204 for issuing commands to the electric field generators 152, 154 to initiate or vary the generated electric field to change the stiffness of the bushing assembly 125. The MR fluid system control module 204 is configured to receive the monitoring output 203 and can access and retrieve information from a look up table stored on the non-transient storage medium 206. The look up table includes information relating MR fluid viscosities at various electric field intensities. The control module 204 processes the monitoring output 203 and the information regarding MR fluid viscosities at various electric field intensities accessed from the look up table in storage 206 to generate a control output 205. The control module 204 additionally determines the desired field intensity based on the desired damping level using information from the look up table in storage 206. The control output 205 is communicated to the electric field generators 152, 154 based on the information received regarding the vehicle operation mode.

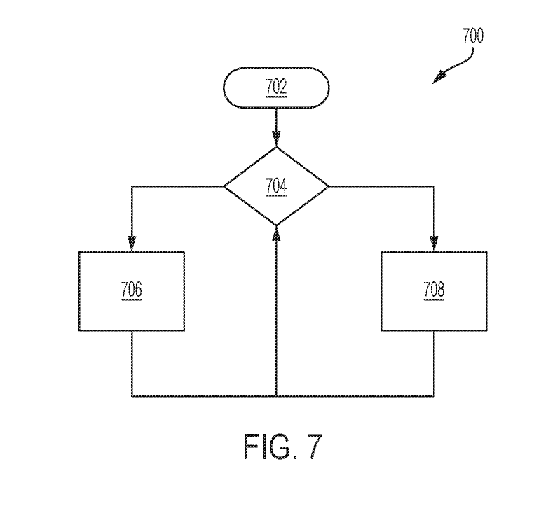

FIG. 7 is a flow chart of a process 700 illustrating the tunable selection of a damping effect of a variable stiffness bushing assembly based on vehicle operation status. The vehicle operation status is determined, for example and without limitation, by user input, detection of a trailer via an electrical wiring connection to the vehicle, a braking event, or an acceleration event, as detected by the controller 22. The process 700 can be utilized in connection with the vehicle 10 and the controller 22, in accordance with exemplary embodiments. The order of operation of the process 700 is not limited to the sequential execution as illustrated in FIG. 7, but may be performed in one or more varying orders as applicable and in accordance with the present disclosure.

When electricity is applied to the electric field generators 152, 154, an electric field is generated. The electric field, combined with the magnetic particles of the MR fluid, causes the MF fluid to change viscosity. By continually varying the electric field produced by the electric field generators 152, 154, the damping effect of the MR fluid can be tuned to compensate for the various bounce frequencies of the propeller shaft. Additionally, the damping effect of the MR fluid can be tuned to help stabilize the propeller shaft from whirling or orbiting when subjected to, for example, high loads. Actively tuning the damping effect of the MR fluid reduces the noise and vibrations transmitted by the driveline to the passengers of the vehicle.

As shown in FIG. 7, the vehicle starts at 702 and the process 700 proceeds to 704. At 704, a determination is made regarding whether the vehicle 10 is operating in a mode in which additional damping of the propeller shaft is desired, such as, for example and without limitation, a high torque damping mode, or a normal driving mode. The damping mode is a driver-activated “active” mode which is activated, for example and without limitation, when a trailer is hooked up to the vehicle 10 (as determined by a detected electrical wiring connection) or when the user presses a tow/haul button provided on the vehicle 10. The normal driving mode is a “passive” mode that monitors acceleration and deceleration events of the vehicle 10 and manages the MR settings to prevent noise and vibration due to whirl.

If the sensor data 27 and user input, if any, indicate that the vehicle 10 is operating in an “active” mode, the process 700 proceeds to 706. At 706, the MR rate is changed, based on information provided by the look up table, such as the table stored on the storage 206, to minimize shaft whirl. For example, and without limitation, when the vehicle 10 is operating in an “active” mode, for example and without limitation, during high torque and low speed operation events, the electric field generators 152, 154 will be commanded by the control module 204 to generate an electric field that causes an increase in the viscosity of the MR fluid, resulting in a stiffer bearing assembly 125. The process 700 cycles back to 704 where additional monitoring of the sensor data 27 and determination of a vehicle operation mode continues throughout the period of operation of the vehicle 10. As discussed above, in some embodiments, propshaft whirl can occur at higher speeds due to 1^{st} order shaft imbalances. In some embodiments, 2^{nd} order vibrations due to change of angles can be another cause of propshaft whirl. If the sensor data 27 indicates that the vehicle 10 is operating under conditions that trigger propshaft whirl, the modules of the controller 22 can act as discussed above to command changes to the viscosity of the MR fluid located in the variable stiffness bushing assembly 125 to adjust the damping characteristics of the bushing assembly 125.

However, if the sensor data 27 does not indicate that the vehicle is operating in an “active” mode (for example, and without limitation, the sensor data 27 does not indicate that the vehicle is towing a trailer or experiencing a heavy braking or acceleration event), the process 700 proceeds to 708. At 708, the electric field generators 152, 154 will be commanded by the control module 204 to generate an electric field according to a predetermined matrix to meet noise and vibration requirements for normal operation. The predetermined matrix is, in some embodiments, a look up table stored on the storage medium 206. The viscosity of the MR fluid resulting from the electric field generated by the electric field generators 152, 154 during normal or “passive” vehicle operation is typically less than the viscosity of the MR fluid commanded when the vehicle is in and “active” operation mode. The process 700 cycles back to 704 where additional monitoring of the sensor data 27 and determination of a vehicle operation mode continues throughout the period of operation of the vehicle 10.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle, comprising:
a transmission;
a differential;
a propeller shaft connecting the transmission and the differential, the propeller shaft having a first shaft and a second shaft, each of the first shaft and the second shaft having a first end and a second end, the first end of the first shaft coupled to the transmission, the second end of the first shaft coupled to the first end of the second shaft, and the second end of the second shaft coupled to the differential;
a bearing assembly configured to couple the second end of the first shaft to the first end of the second shaft, the bearing assembly comprising a bearing, a bearing support, a chamber formed within the bearing support, at least one electrical field generator embedded within the bearing support, the chamber filled with a magnetorheological fluid;
wherein a stiffness of the bearing assembly is adjusted by varying an intensity of an electric field applied to the magnetorheological fluid.

2. The automotive vehicle of claim 1, further comprising at least one sensor configured to detect a vehicle operation characteristic and a controller in electronic communication with the at least one electric field generator and the at least one sensor, the controller configured to receive sensor data from the at least one sensor and command an electric field intensity based on an operational mode of the vehicle.

3. The automotive vehicle of claim 2, wherein the operational mode of the vehicle is one of an active mode and a passive mode.

4. The automotive vehicle of claim 3, wherein the stiffness of the bearing assembly is higher when the vehicle is operating in the active mode than when the vehicle is operating in the passive mode.

5. The automotive vehicle of claim 4, wherein the active mode includes a mode of operation of the vehicle in which the vehicle is towing a load.

6. The automotive vehicle of claim 4, wherein the active mode includes a mode of operation of the vehicle in which the bearing orbits in an elliptical direction along a longitudinal axis defined by the propeller shaft.

7. A propeller shaft, comprising:
a first shaft and a second shaft, each of the first shaft and the second shaft having a first end and a second end, the second end of the first shaft coupled to the first end of the second shaft with a joint; and
a variable stiffness bushing assembly coupled to one of the first and the second shafts near the joint, the variable stiffness bushing assembly having a bearing, a bearing support encircling the bearing, a chamber formed in the bearing support, and at least one electric field generator, wherein the chamber contains a magnetorheological fluid.

8. The propeller shaft of claim 7, wherein the at least one electric field generator is embedded in a wall of the chamber.

9. The propeller shaft of claim 7, wherein the propeller shaft transmits power from a vehicle transmission to at least one vehicle wheel.

10. The propeller shaft of claim 7, wherein the at least one electric field generator is configured to generate a desired electric field intensity based on an operational mode of the vehicle.

11. The propeller shaft of claim 10, wherein the operational mode of the vehicle is one of an active mode and a passive mode.

12. The propeller shaft of claim 11, wherein a stiffness of the bushing assembly is higher when the vehicle is operating in the active mode than when the vehicle is operating in the passive mode.

13. The propeller shaft of claim 12, wherein the active mode includes a mode of operation of the vehicle in which the bearing orbits in an elliptical direction along a longitudinal axis defined by the propeller shaft.

14. A method for controlling a variable stiffness bushing assembly of a vehicle, the method comprising:
providing the vehicle with at least one sensor configured to measure at least one vehicle characteristic;
providing the vehicle with the variable stiffness bushing assembly, the bushing assembly comprising a bearing and a bearing support encircling the bearing, a chamber formed in the bearing support, the chamber containing a magnetorheological fluid, and at least one electric field generator embedded in a wall of the chamber;
providing the vehicle with a controller in electronic communication with the at least one sensor and the at least one electric field generator;
receiving, by the controller, vehicle data corresponding to the at least one vehicle characteristic from the at least one sensor;
determining, by the controller, a desired damping level based on the vehicle data; and
controlling, by the controller, the at least one electric field generator to generate a desired electric field intensity.

15. The method of claim 14, further comprising determining, by the controller, an operational mode of the vehicle and commanding, by the controller, the desired electric field intensity based on the operational mode of the vehicle.

16. The method of claim 15, wherein the operational mode of the vehicle is one of an active mode and a passive mode.

17. The method of claim 16, wherein the stiffness of the bushing assembly is higher when the vehicle is operating in the active mode than when the vehicle is operating in the passive mode.

18. The method of claim 14, further comprising accessing, by the controller, information stored on a non-transient storage medium regarding a magnetorheological fluid viscosity for the desired electric field intensity.

19. The method of claim 14, further comprising determining, by the controller, the desired field intensity based on the desired damping level.

20. The method of claim 14, wherein the at least one vehicle characteristic includes one or more of a vehicle speed, a vehicle acceleration, and a vehicle deceleration.
